(19) United States
(12) Patent Application Publication
(10) Pub. No.: US 2008/0037397 A1
(43) Pub. Date: Feb. 14, 2008

(54) Methods And Apparatus For The Fixing Of Holographic Media In Holographic Data Storage Systems

(75) Inventors: David A. Waldman, Concord, MA (US); Christopher J. Butler, Arlington, MA (US); Daniel H. Raguin, Acton, MA (US)

Correspondence Address: KENNETH J. LUKACHER, SOUTH WINTON COURT, 3136 WINTON ROAD SOUTH, SUITE 301, ROCHESTER, NY, 14623, US

(73) Assignee: DCE APRILIS, INC., Maynard, MA (US)

(21) Appl. No.: 10/582,264

(22) PCT Filed: Dec. 10, 2004
(86) PCT No.: PCT/US04/41793

§ 371 Date: May 21, 2007

Related U.S. Application Data
(60) Provisional application No. 60/529,013, filed on Dec. 12, 2003.

(51) Int. Cl. G11B 7/00

(52) U.S. Cl. 369/103

(57) ABSTRACT

Holographic data storage systems are fixed after exposure during which data in the form of holograms are stored at locations in the medium (4). Sufficient fixing energy in the form of light or other electromagnetic and thermal radiation is applied to the media (4) either by flooding the media, or to specific locations where the medium has been written. The energy is sufficient to expose the recorded medium (4) to prevent recording in the unused dynamic range thereof. Such recording can be a spurious recording made during readout or from spurious sources of light incident on the media. In one embodiment, the reference beam (108) produced in the course of holographic recording is redirected to locations on the media (4) which have already been recorded. The redirected beam post exposes the media to fix these locations against spurious recording. The integrity of the holographic data storage systems and the robustness thereof is improved by fixing methods and apparatus incorporating the invention.

This Application claims priority to U.S. Provisional Patent Application No. 60/529,013, filed Dec. 12, 2003, which is herein incorporated by reference.

### FIELD OF THE INVENTION

This invention relates to holographic data storage, and particularly to methods and apparatus for improving the integrity or robustness of holographic data storage media by controlling the storage of data in the dynamic range of the media outside the range being used for recording. The remnant dynamic range of a holographic media is consumed, thereby making the holographic media insensitive to further illumination which would otherwise affect the holographic media, and especially insensitive to further recording events or modification or erasure of the recording during read-out. The operation of the methods and apparatus provided by the invention is herein called, fixing of the photosensitive holographic media. In accordance with this invention, the fixing of a holographic media can be accomplished either inside or outside of the holographic data storage system (HDSS) used to record data into the media. Fixing holographic media may be carried out using an optical source, where the optical source can be the same optical source used to write and/or read data in a HDSS or may be a separate source either inside or outside of the HDSS. Fixing of the media in accordance with this invention may be carried out by applying heat alone or in conjunction with optical exposure of holographic media.

### BACKGROUND OF THE INVENTION

In holographic data storage systems (HDSS) multiple pages or bits of data are co-located, as by being multiplexed in the same spot, in the media. As such, a suitable photosensitive holographic media must have sufficient dynamic range for this co-locational recording to be achieved. Typically holographic media, such as the photopolymer materials marketed and sold by InPhase Technologies (Longmont, Colo. USA) and Aprilis, Inc. (Maynard, Mass., USA), have an exposure curve that requires successively higher exposure doses for each new data page that is to be holographically co-locationally recorded.

FIG. 1 depicts the exposure curve for a 400 μm thick photo addressable polymer media, produced by Aprilis, Inc., that was recorded with 148 co-locational holograms, wherein each hologram was a 512×512 pixel page. For each successive hologram recorded into the media with approximately the same resolution, the required exposure dose increases at a non-linear rate. The available dynamic range or cumulative grating strength (M/#) of a holographic material is determined by the number of holograms M that can be recorded into the material, preferably all at substantially the same diffraction efficiency η. As illustrated in FIG. 1, as one writes more holograms into a photopolymer holographic media, one must monotonically increase the exposure fluence to maintain constant diffraction efficiency for each new hologram. In the laboratory the consequence of the increased exposure fluence, or effectively the increased writing time, for each new hologram may not be of consequence. However, in a practical holographic optical data storage product, increasing exposure dose of each newly recorded hologram means that the write rates of the HDSS will be steadily decreasing with each successive co-locational hologram that is written. Also a laser must be used having sufficient power to provide the exposure for the last successive co-located hologram. The later is undesirable since the high-power laser can present an environmental hazard subject to governmental regulations, let alone requiring an excessive electrical power for the HDSS. Accordingly the exponential increase in the required exposure dose for each successive hologram co-locationally recorded into a holographic media, may restrict the total number of holograms that can be practicably stored at each location in a holographic media and therefore limit the storage capacity of the HDSS.

The remnant, unused dynamic range presents another pervasive problem, since the media is still sensitive to illumination. This illumination may create spurious adverse effects which interfere with the holograms which are recorded. These effects may be manifested by errors or noise, especially on read-out. The energy to which the media is exposed during read-out may result in spurious recording or over-writing of holographic recordings (gratings) which interfere with and produce noise on read-out.

It is a principal feature of the present invention to reduce these spurious effects by making the medium insensitive outside of the portion of its dynamic range which is being used, and especially to spurious recording events, as from a read-out beam. Fixing the medium in accordance with the invention mitigates against recording in the unused dynamic range, and the pages of recorded data are not compromised.

The exposure schedule of FIG. 1, illustrates that the HDSS may be restricted to record only co-locational holograms that require less than 10 mJ/cm² exposures. Exposure times required for holograms requiring greater than 10 mJ/cm² may be too long compared to the vibrational modes of the system, and such longer exposure times can compromise the write rates of the HDSS. In the specific example of FIG. 1, the 10-mJ/cm requirement means that 132 or 89% of the available 148-page holographic storage capacity or dynamic range is recorded. The cumulative exposure dose the holographic media will be exposed to for such 89% level storage is 284 mJ/cm² versus 742 mJ/cm² required for the full 100% level storage which is a 458 mJ/cm² difference. In accordance with the invention, the media is fixed by applying an additional exposure dose which prevents recording over the unused dynamic range. Therefore, a minimum of 458 mJ/cm² additional exposure dose is required in order to consume the unused dynamic range of the holographic media presented in this example. The additional exposure may be larger in that it is preferential to expose the holographic media to a cumulative exposure dose that is higher than for the 100% storage capacity level.

Consider that if the media, after being recorded with the initial 132 co-locational holograms is not given a fixative post-exposure, then any reading of the recorded data by a read-out beam (usually the reference beam) will result in additional undesired gratings being formed in the media. These undesired gratings, termed spurious or noise gratings, may be formed by the reflections of the reference beam off of internal or external interfaces of the holographic media or off of any surface within the holographic optical drive. The reference beam and reflections, thereof, may interfere or the referenced beam may interfere with itself, or with the diffracted light of the hologram or holograms stored within the holographic media. These spurious or noise gratings will result in the reduction of the signal-to-noise ratio (SNR) of the system and increase the bit error rate (BER) of the optical drive.

It is therefore an important feature of the invention to provide a high-performance holographic recording system, such as used in an optical drive, wherein the unused or remaining dynamic range of the medium is essentially consumed and fixed against further exposure or recording. The consumption of the remaining dynamic range of a holographic media in accordance with the invention renders the holographic media insensitive to additional optical exposures, thereby fixing the media and preserving the co-located holographic recordings thereon.

### SUMMARY OF THE INVENTION

Briefly described, this invention may be applied to holographic data storage to accomplish the fixing of a holographic media either inside or outside of the holographic data storage system (HDSS) used to record data into the media. A fixing source is provided that can be the same source used to write and/or read data in the HDSS, or a separate source may be located either inside or outside of the HDSS. The fixing source emits electromagnetic wavelengths to which the holographic media is photosensitive. The source may be an optical source that emits wavelengths which the holographic media will absorb, thereby causing the holographic media to heat up. The fixing source may alternatively be a heat source, which may or may not emit such wavelengths. A combination of two or more of the aforementioned sources may be used. The holographic media may be fixed throughout the entire volume of the holographic media simultaneously, or selectively by operating on a fraction of the holographic media at a time.

More specifically, the holographic media may be fixed using electromagnetic (EM) radiation that the holographic media is photosensitive to. Preferably, the EM source has a radiation spectrum that is concentrated in a range of wavelengths where the holographic media is most sensitive, thereby enabling the holographic media to be fixed rapidly and minimize electrical power for operating the source. The EM source should also provide incoherent energy, thereby minimizing the creation of any noise gratings during the exposure time required to consume the remaining dynamic range of the holographic media. An incoherent source may be for example an incandescent or fluorescent lamp, a low-coherence light emitting diode (LED), or an array of low-coherence LEDs.

A laser source can also be used. This laser source is preferably made incoherent, as by the use of a rotating diffuser plate that is placed in front of the laser source or in the path of an optical beam from the laser source. The laser source is preferably incident upon the media at an angle sufficiently different from the angles used during recording of data pages to reduce exposure at locations in the medium used for recording. In this manner, any noise gratings that are produced during fixing are not Bragg-matched to the gratings that were recorded for the purposes of storing data within the holographic media. Noise gratings may also be precluded or not produced or that the strength of such noise gratings may be reduced by moving the fixing source or the holographic media such that any holographic fringes produced during fixing are washed out. The fixing source can have one or more optical elements of the system relaying a fixing beam to the holographic media, which elements vibrate or move in a rapid enough manner, such that any fringes produced during the fixing process are washed out. Where the holographic media is in the form of a disc, the disc can be rotated at a sufficiently high rate (rpm) such that fringes produced during the fixing process are washed out.

The EM radiation source used to fix the holographic media may be separate from the read/write EM radiation source of the HDSS. This EM source can be contained within the HDSS or may be outside of the HDSS. For example, when the HDSS is part of a larger data storage system, the EM source can be contained within the larger data storage system, but separate from the HDSS. The fixing process can be accomplished such that the entire holographic media is fixed simultaneously or only a portion of the media is fixed at a time.

Where the same EM radiation used for writing and or reading within the holographic optical drive is used for the fixing of the holographic media, the strength of any noise gratings recorded during fixing may be reduced by reducing the coherence length of the EM radiation (for example, through the use of a rotating diffuser) or by having at least one surface that moves (for example, vibrates) at a sufficiently high rate so as to wash out any fringes which might be created during fixing.

If desired, the fixing of the holographic media may be accomplished simultaneous with data recording events that are occurring at a different region of the holographic media than that which is being fixed. For example, a portion of the reference beam used in the recording of the holographic media is used to fix the holographic media in a region that was previously recorded with data and requires fixing. In this case the reference beam is sized so that a portion overlaps with the object beam and is used for recording holographic data, while the other portion that does not overlap with the object beam is used to expose media and thereby fix it.

The reference beam may be used for fixing by redirecting all or a portion of the reference beam that is transmitted through the holographic media back to the holographic media to locations on the holographic media that have already been filly written by the optical recording system over the limited dynamic range. Preferably, the redirected reference beam is modified in such a way that when it is incident upon the holographic media surface it is not Bragg matched to any of the data gratings previously written in the location being post-exposed and fixed. In this manner, while the media is being written (say, on a track of a disc media), prior written locations on other tracks or the same track can be fixed. In the case using the redirected reference beam, required exposure dose for post exposure fixing is preferably less than the cumulative exposure dose the holographic media receives during writing of data. For cases in which the additional amount of optical exposure required exceeds the cumulative exposure for data writing, the reference beam may be double or triple-passed through the media until regions of the holographic media requiring fixing receive the required dose for fixing. The redirecting of a fixing beam such that the beam exposes the holographic media several times applies to cases wherein the fixing beam originates from the source used for writing, as well as for cases wherein a separate fixing source, either internal or external to the HDSS, is used.

Where fixing is accomplished through the heating of the holographic media, direct heat sources (for example, resistive heat sources) may be located inside, outside, or inside and outside of the HDSS that is recording holographic media. The holographic media may be fixed by heat-treating the entire holographic media simultaneously (flooding with heat) or in localized regions of the holographic media. Indirect heating of the media through indirect means may be used, for example with an EM source that contains wavelengths that cannot record gratings within the holographic media, but will still be absorbed by the holographic media. The absorbed energy is then converted to heat which fixes the holographic media. For the case of a holographic media that contains metals or other highly conductive materials, inductive heating can be used. Fixing of holographic media may also be carried out through a combination of heating and optical exposure.

### BRIEF DESCRIPTION OF THE DRAWINGS

The foregoing and other features and advantages of the invention will become more apparent from a reading of the following detailed description in connection with the accompanying drawings in which:

FIG. 1 is a plot presenting the non-linear exposure schedule for the required exposure fluence as a function of data page hologram (M) for a photopolymer used for holographic data storage;

FIG. 2 is a schematic diagram of an HDSS embodying the present invention;

FIG. 3 is a diagram schematically illustrating the operation of a first embodiment of the invention wherein an oversized reference beam is used to fix areas of the holographic media that were previously recorded with data in a cross-section of a holographic media;

FIG. 4 is a diagram similar to FIG. 3 schematically illustrating a second embodiment of the invention wherein the reference beam transmitted through the holographic media during writing is redirected to expose other portions of the holographic media (a cross section of which is shown) that require fixing;

FIG. 5 is a schematic plan view of a holographic media in disc form illustrating the locations being fixed in non-abutting relationship to the location being simultaneously recorded;

FIG. 6 is a diagram similar to FIGS. 3 and 4 showing a third embodiment of the invention, the diagram illustrating a cross-section of a holographic media and a first optical system, for redirecting the reference beam transmitted through the holographic media during writing to expose other portions of the holographic media that require fixing, and a second optical system for redirecting the initially redirected reference beam back at the media;

FIG. 7 is a schematic diagram similar to FIGS. 3, 4 and 6 showing a fourth embodiment of the invention wherein a separate fixing source is incorporated inside of a HDSS;

FIG. 8 is a schematic diagram showing a cross-section of a holographic media with an apparatus for fixing a holographic media that is entirely outside of the HDSS which records the data within the holographic media, all in accordance with a fifth embodiment of the invention;

FIG. 9 is a schematic diagram showing an example of an apparatus for the fixing of a holographic media thermally in accordance with a sixth embodiment of the invention; and

FIG. 10 is a schematic perspective view of a portion of an HDSS having an apparatus for fixing a portion of a holographic media contained within a cartridge, all in accordance with a seventh embodiment of the invention.

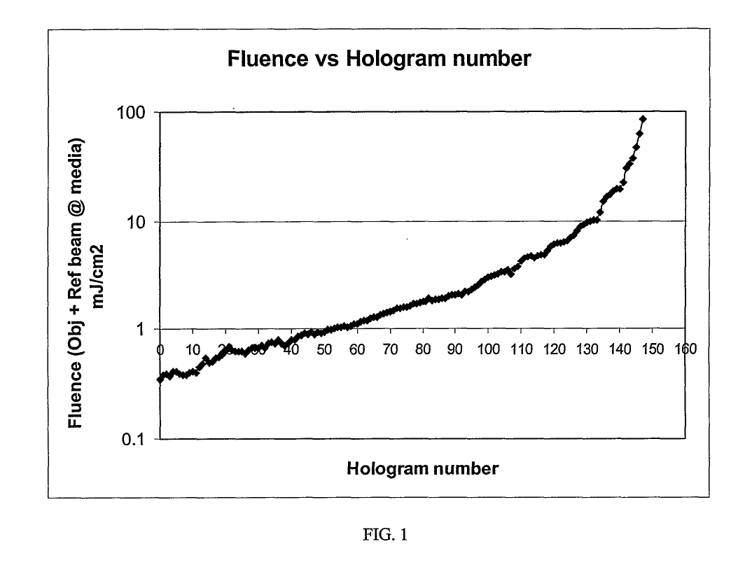

### DETAILED DESCRIPTION OF THE INVENTION

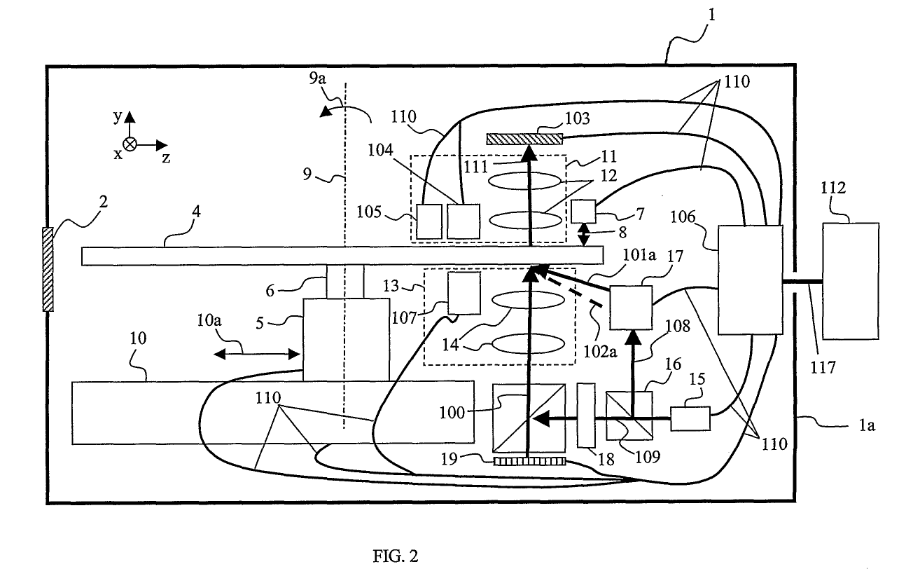

FIG. 2 depicts a HDSS 1 in a light tight enclosure la. The HDSS uses a disc providing a removable holographic media 4. The enclosure 1 a has an aperture 2, preferably light-tight, through which holographic media 4 can be inserted into the HDSS. The holographic media may be contained within a cartridge. An example of such a cartridge is described in U.S. Provisional Patent Application No. 60/510,914, now U.S. patent application Ser. No. 10/965,570, and International Application PCT/US04/33921, both filed Oct. 14, 2004. For simplicity of illustration, the cartridge, and associated shutters and shutter mechanics for the cartridge are not shown. For simplicity of illustration, the cartridge loader or other movable fixture that accepts the inserted holographic media and ensures that said holographic media is aligned and mated to the mechanics required to actuate said media within the HDSS are also not illustrated. In FIG. 2 the holographic media 4 is shown attached to a rotary spindle 6 that is attached to a rotary motor 5. In this manner, the media can be rotated radially about an axis 9 in the directional sense indicated by arrow 9a. The rotary motor 5 is attached to a linear stage 10 that moves the rotary motor and hence the holographic media along the z direction, indicated by 10a, across the stationary optics of the write optical module 13 and the read optical module 11. Through the rotary motion of the rotary motor 5 and the linear translation of the linear stage 10, a large annular portion of the holographic media can be addressed. The geometry depicted in FIG. 2 is only one example of how a holographic media within an HDSS can be addressed. For example, the holographic media may rotate while the optical modules for reading and writing move across the media. The holographic media can be stationary, and only the optical modules can move physically to direct the appropriate read and/or write beams towards the disc surface. The optics can be stationary, while the holographic media is actuated in the x and y directions through the use of appropriate x and y stages rather than rotated in about an axis 9 and moved in orthogonal directions 10a, as depicted in FIG. 2. The invention may be embodied in the foregoing or other HDSS systems and other systems using holographic media.

FIG. 2 illustrates an exemplary HDSS with a transmissive holographic geometry in that the write optical module 13 and the read optical module 11 are on opposite sides of the holographic media 4. Each of the write and read modules contain a number of optical elements 14 and 12 lenses being shown by way of example.

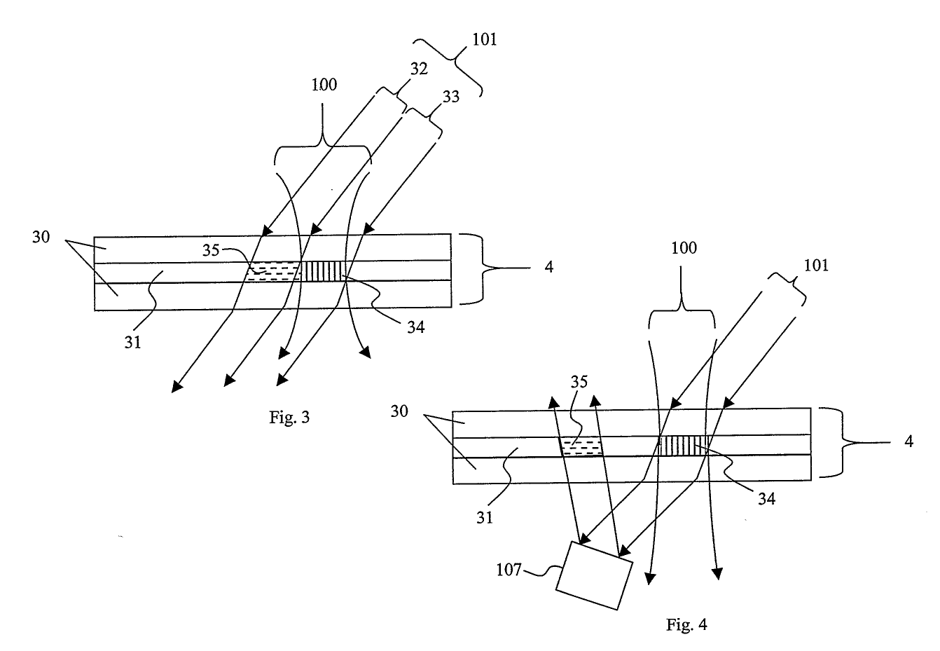

The read and write modules 11 and 13 may have a plurality of separate optical systems 104 and 107 (for simplicity only one of each of these systems is diagrammed) that are used, for fixing purposes per the invention to redirect the reference beam transmitted through the holographic media 4 and again to redirect the redirected reference beam back through the holographic media. These optical systems 104 and 107 may be dynamic (for example have optical elements and/or opto-mechanical components that move). To control such movement, the systems 104 and 107 are connected to a controller 106 via control cables 110. The position and orientation of the optical systems 104 and 107 are controlled in relation to positions of the optical elements 14 that are performing the data recording. The use of optical systems to redirect the reference beam will be described in greater detail in connection with FIGS. 4-7.

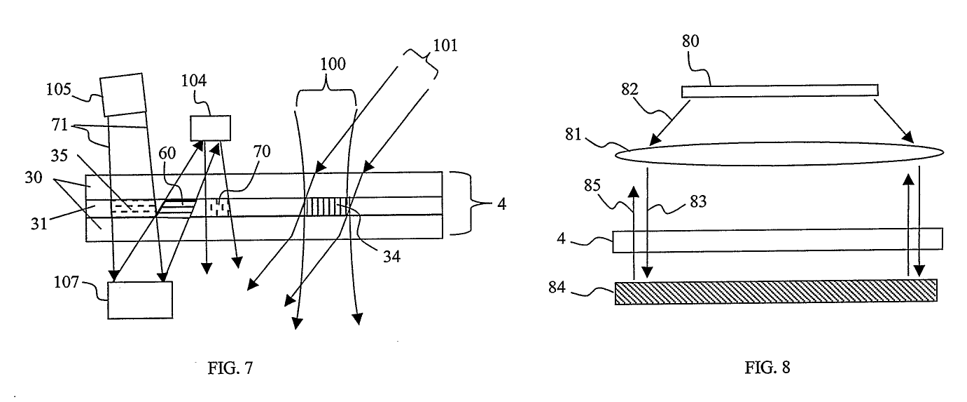

Fixing can also be carried out using a source 105. Then, the read and write modules contain, at least one fixing source 105, that, although drawn as part of the read module, can be placed in either the read module 11, the write module 13, or in both modules. The use of a fixing source is discussed herein after in connection with FIGS. 7-9.

In the example of the HDSS depicted in FIG. 2, light from an optical source 15, preferably a laser, is split into two beams via a beam splitter 16. One of the split beams is the object beam 109 and it is preferably beam shaped by a beam shaping optical system 18 such that the intensity falls on the spatial light modulator (SLM) 19, which has (or displays) data to be written. The light 100 from the SLM is relayed to the holographic media 4 via the optical elements 14 of the write optical module 13. The second of the two beams split from the beam splitter 16 is the reference beam 108. This beam passes through a reference optical system 17 that shapes the reference beam and directs that beam towards the holographic media to interfere with the object beam 100. Depicted in FIG. 2 is an example of how two separate reference beams, 101a and 102a may be sequentially incident upon the holographic media at different orientations in the case of planar angle and or peristrophic (azimuthal) multiplexing. Other forms of multiplexing that are provided by system 17, such as speckle and shift multiplexing, may alternatively be used with HDSS 1.

For reading of data from the holographic media, the object beam may be prevented from illuminating the holographic media. The blocking of the reference beam can be accomplished by an opto-mechanical system (not shown). Examples of such opto-mechanical systems are mechanical shutters, EO or AO shutters or deflectors, or polarization rotation devices where beamsplitter 16 is a polarization beam splitter. When reading the data stored in the holographic media, the reference beam illuminates the holographic surface with a series of reference beam orientations and wavefronts that match the orientations and wavefronts of the reference beams used during the writing process. When a given reference beam that matches a reference beam used in the recording process illuminates the media, the stored hologram can be read and the diffracted light 111 from this hologram is captured by optical elements 12 of the read module 11 and imaged onto a detector 103. During both read and write cycles of the HDSS, a servo system 7 can be used to track the holographic media position. This servo system can use an optical beam 8 to detect position information from the holographic media. Aside from the fixing apparatus provided by the invention, more information of HDSS may be obtained in patents and publications on the foregoing and other HDSS implementations, such as Pu et al., U.S. Pat. No. 5,483,365 issued Jan. 9, 1996 and J. Ashley et al. “Holographic data storage,” IBM J. Res. Develop., Vol. 44, No. 3, Page 341 (May 2000).

Many of the opto-mechanical systems in an HDSS require dynamic control and are connected via cables (e.g., electrical or optical), to one or more controllers 106. The controllers within the HDSS can perform a multitude of tasks, for the control and timing of the data displayed by the SLM 19, the modulation and power levels of the optical source, the receiving and decoding of data received from the detector, the servo controls for tracking the holographic media, and the control and timing of the reference beam wavefront and or angle required for the specific multiplexing configuration of the HDSS. The controller may be a programmed microprocessor-based device, and can also supply any electrical power needed by these various opto-mechanical systems via the connections illustrated by 110. The HDSS internal controller(s) are connected to an external controller 112 via a connection 117, fed into enclosure la through the light-tight opening. This external controller can be a computer, such as a personal computer, an enterprise library data storage system, or a computer server.

The fixing of holographic media 4 within the HDSS 1 is carried out post exposure, or after data is recorded at a location in the media or after the media is entirely recorded. For example, one can first record the required holographic data in a set of locations (spots) of the holographic media using beams 100 and 101a and then go back to these recorded locations and perform fixing using preferentially only the reference beam 101a oriented at an angle offset to the angle of the reference beam during recording, or with a beam having a wavefront that is not Bragg matched to the previously recorded data.

FIGS. 3 through 7 illustrate embodiments of fixing implementations (apparatus) that enable the simultaneous fixing of locations of a holographic media that have been previous written to, while yet other locations within said holographic media are being or will be written to. FIG. 3 depicts a cross section of the recording plane of the holographic media 4 within the HDSS 1. In this example, holographic media 4 composed of two substrates 30 that sandwich a photosensitive material 31, as is the case for photosensitive holographic photopolymerizable materials that are mentioned above or other similar commercially available materials. An object beam 100 and a reference beam 101 interfere at the holographic media. A portion of the reference beam 33 interferes at the photosensitive material 31 to record a hologram in a location 34 represented by the vertical hash marks. Another portion of the reference beam 32 does not interfere with the object beam, but rather exposes the photosensitive media in a region 35 that has been previously recorded and is desired to be post-exposed. For example, if a holographic media is recorded in a step-and-repeat fashion, then while a certain location on the holographic media is being recorded, the previously recorded location on the media is fixed. As another example, for the case of a disc holographic media, when one track of the disk is being recorded, the previously recorded track can be fixed. Although a transmission grating geometry using a sandwiched photosensitive media is depicted in FIG. 3 and other figures in this disclosure, the embodiments described herein can be applied in HDSS systems that work in reflection mode and with holographic media that is not sandwiched by two substrates, the later being presently less preferable implementations.

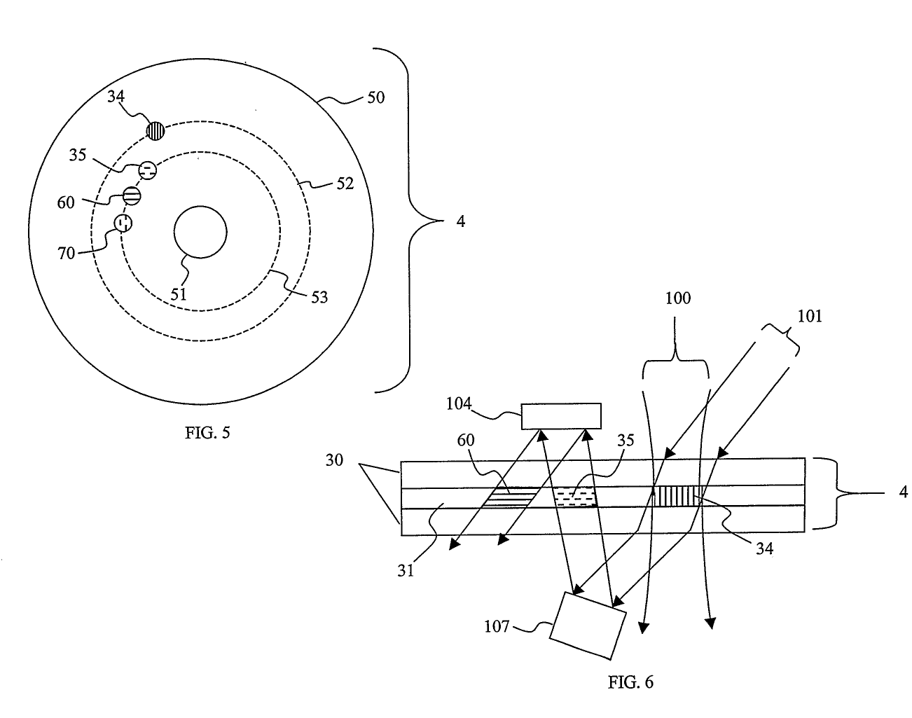

In the fixing apparatus shown in FIG. 4 an oversized reference beam used in the FIG. 3 implementation is not required. Instead, the reference beam 101 is shaped such that its footprint approximately matches the footprint of the object beam 100 at the location of the photosensitive media 31 which has been written to. The transmitted portion of the reference beam is redirected by an optical system 107 to a portion of the photosensitive media that requires fixing. The advantage of incorporating optical system 107 is that the area 35 being fixed by the reference beam does not need to be abutting area 34 that is simultaneously being recorded. For the example of a holographic media that is in a disc format with outer diameter 50, see FIG. 5, a location 35 on track 53 can be fixed while a location 34 on track 52 can be simultaneously written. Another advantage of system 107 is that it can be designed such that the reference beam that is redirected towards 35 has a wavefront and/or a propagation direction that is not Bragg-matched or is not nearly Bragg-matched to any of the holograms that were recorded as part of the data writing process.

The optical system 107 may be a flat mirror that redirects the reference beam back to the holographic media; however, redirection and refocusing may use a system of reflective elements and or transmissive lenses, diffractive elements, or Fresnel elements. For angle or peristrophic multiplexed holograms, it is preferable that the area exposed to the redirected reference beam does not change in location relative to the area that is simultaneously being written to as a function of the reference beam's 101 propagation angle. The optical system 107 then may be an aspheric mirror that is approximately ellipsoidal, with one foci of its ellipsoidal reflecting surface corresponding to location 34 and the other foci of the ellipsoidal surface corresponding to location 35. Where the reference beam 101 is a spherically diverging beam, as is used for providing shift-multiplexed holograms, the optical system 107 may be a concave mirror that collects the transmitted expanding reference beam and redirects it towards the holographic media.

A device such as a diffuser that is stationary or dynamic (e.g., rotating, oscillating, or in other words moving) may be incorporated into the optical system 107 such that the redirected reference beam has a reduced coherence length compared to the initial reference beam, initially transmitted through the holographic media for recording. In a preferred embodiment, the optical system 107 is incorporated into the HDSS such that the location 35 on the media is fixed in spatial relationship to the location 34 on the holographic media that is being written to. Therefore, optical system 107 and the optics 14 used for the recording are preferentially fixed relative to each other as different areas of the holographic media are addressed. Since the photosensitive media is not opaque to the incident beams, the reference beam is not depleted and the residual transmitted energy may be used for fixing purposes at locations previously written to. For example, a media containing photopolymer material from Aprilis, Inc. transmits 70-90% of light incident on the media, thereby leaving a significant amount of light which may be redirected towards the holographic media for the purposes of fixing.

Referring to FIG. 6, a second optical system 104 is added in order to redirect the reference beam again back towards a location 60 of the holographic media that requires fixing. In some HDSS the reference beam is varied in the angle at which the beam strikes the surface. In order for the optical system to reflect the light to the same location of holographic media that requires fixing regardless of the angle that the beam makes at the surface, an aspheric mirror provides the optical system 104. This aspheric mirror may approximate an ellipsoidal reflecting surface such that the two foci of the ellipsoid correspond to the region 35 and to the region 60. Preferably the aspheric mirror redirects the reference beams at angles such that the redirected beams are not Bragg-matched to any of the holograms recorded in region 60. As diagrammed in FIG. 5, region 60 can be along the same track as 35, if desired. Thus, while track 52 is being recorded, track 53 can be fixed. Additional optical systems can be added in tandem such that the reference beam is redirected towards the holographic media more than twice as illustrated in FIG. 6.

As an illustrative example of the benefit of redirecting the reference beams using optical systems 104 and 107, consider a holographic media that, due to a threshold set on the exposure dose per hologram, results in a cumulative exposure of 400 mJ/cm². Further consider that the object beam and reference beam are approximately equal in power density and that the holographic media transmits 85% of the incident optical power. Using the geometry depicted in FIG. 6, the reference beam is redirected twice back towards the media, the amount of energy that is available for fixing is 315 mJ/cm², without requiring a reduction in the write rate of the HDSS. For this exposure example, without this particular embodiment of this invention, if an additional 315 mJ/cm² of fixing exposure were required of the optical system performing the data writing, this would translate to a 44% reduction in the write rate of the HDSS.

FIG. 7 depicts a cross-section of a holographic media that incorporates a separate fixing source 105. In one embodiment, the fixing source emits wavelengths that the holographic media is photosensitive to. The fixing source 105 incorporates an opto-mechanical system for directing light from the fixing source towards the holographic media 4. The light source contained within source 105 is preferentially an incoherent source, such that noise gratings are not recorded by the source in the media 31. For example, the incoherent source can be incandescent or fluorescent, but is preferably a highly efficient source (with high electrical to optical power conversion efficiency) such as a LED. Alternatively, the light source can be made incoherent through the use of a static or dynamic diffuser. Alternatively, the fixing source 105 may incorporate one or more vibrating optical elements. Then, even if a coherent light source is used, any interference fringes created in the holographic media will be washed out and have minimal effect on the BER of any holographic data that is read out. If only a single location is required to be fixed per location 34 that is simultaneously recorded, then only one fixing source 105 is present in the HDSS. If two locations are required to be fixed, redirecting optical system 107 is added. If three locations are required, optical system 104 is added. These additional optical systems 104 and 107 are designed such that they redirect the transmitted light 71 emitted by 105 towards a portion of the holographic media requiring fixing. The optical systems 104 and 107 can incorporate aspheric mirrors that are approximately elliptical, such that the light emerging from region 35 is redirected to region 60 by optical system 107 and the transmitted light from region 60 redirected to a region 70 by an optical system 104. Since the optical beam from 105 does not necessarily change angle as a function of hologram number for a specific recording location on the holographic media (as does reference beam 101 in the case of angle and/or peristrophic multiplexing), the optical systems 107 and 104 need not be aspheric mirrors, but may be plano mirrors.

With a separate fixing source in the HDSS, the fixing of the holographic media can be accomplished simultaneous with the recording of data, as well as when the HDSS is not recording any new data on a fully or partially recorded holographic media (disc). An advantage of having a separate fixing source within the HDSS is that the fixing source can be higher power than the optical source required for writing (the reference beam source). The separate fixing source can fix the holographic media with sufficient exposure dose without compromising the HDSS writing rate. A fixing beam, whether the beam used in recording or a separate beam, may be redirected through the same location in the media more than once to achieve a level of optical fluence for the purposes of fixing a holographic media. Then, additional optical systems 104 and 107 may be added to redirect said reference beam a plurality of times.

The geometrical arrangement shown in FIG. 7 is useful for the thermal fixing of the photosensitive media for holographic data storage. The fixing source 105 then emits wavelengths that are absorbed by the holographic media 31. The energy from the absorbed wavelengths may re-emit in the form of heat. For example, IR (infra red) wavelengths that a particular holographic media can absorb and re-emit in the form of heat can be used in a HDSS for fixing. Ideally the wavelengths chosen to heat up the photosensitive material are such that a significant fraction of the incident radiation is absorbed (for example>90%). A plurality of optical systems, such as the systems 104 and 107, can be used to redirect the heat wavelengths. The use of system 107 or even additional optical system 104 depends upon the absorption levels of the heating wavelengths.

The fixing source 105 may be a thermal source such as a resistive heater. The fixing of the holographic media is then accomplished via radiation or convection heating. In the case of a thermal source, optical systems 104 and 107 may be incorporated to reflect the heat towards the regions of the holographic media that require fixing. The thermal source may emit wavelengths the media is sensitive to, but alternatively need not emit such wavelengths.

In FIGS. 4, 6, and 7, the optical systems 104 and 107 and the fixing source 105 may be oriented by the controller 106, such that the orientation and/or the beam shape of the radiation that is performing the fixing is varied as a function of memory location on the holographic media or the particular hologram sequence that is being recorded (See FIG. 2).

The fixing source 105 can be within the HDSS that is performing the writing and recording of data, but can also be located outside the HDSS. For example, in a library system wherein holographic media is taken from storage slots and inserted into a holographic optical drive for reading and recording, fixing can be carried out at locations outside of the HDSS enclosure. Depending upon the format structure of the holographic media, when formatting structures support multiple writing and reading sessions to a holographic media, multiple fixing sessions inside or outside the HDSS enclosure may be used with formatting structures which support only a single writing session, only a single fixing session inside or outside the HDSS may be used.

For the case wherein only a single fixing session is required and wherein the entire holographic media can be fixed simultaneously, the fixing apparatus depicted in FIG. 8 may be used. A holographic media 4 is exposed to an optical source 80 wherein the light 82 from said source is directed towards the holographic surface using an optical system 81 such that rays 83 expose the holographic media; that is the media is flooded. The optical source wavelengths may directly expose the holographic media or the source wavelengths may be wavelengths that the holographic media absorbs (e.g., IR and microwave radiation) and which are reradiated in the form of heat. The flooding optical source can have wavelengths that satisfy both of these criteria (direct or indirect thermal exposure) for the purposes of fixing. A reflector system 84 can be used to reflect some of the transmitted light back towards said holographic media such that rays 85 expose the holographic media 4. Although drawn in FIG. 8 as a planar mirror, the reflector system 84 can be curved and wrap partially around or fully around the holographic media and the optical source in order to maximize that amount of light directed towards the holographic media for the purposes of fixing. It is preferred that the optical source 80 is incoherent. The strength of any recorded noise gratings may also be reduced as by using a rotating diffuser, or vibrating one or more optical elements 81 in which to direct the light from the optical source. Although a single holographic media is shown in FIG. 8, multiple ones of the holographic media may similarly be exposed at the same time by flooded light directed from an optical source.

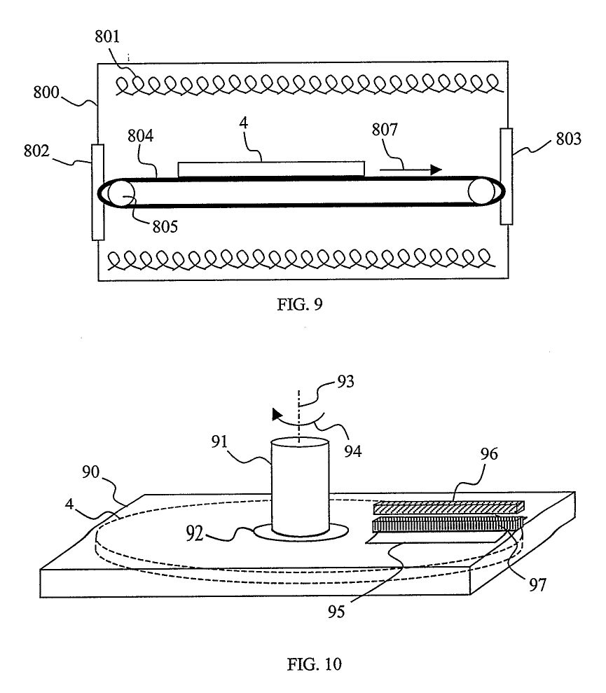

Referring to FIG. 9, a fixing apparatus is shown that is capable of fixing a holographic media in its entirety. A thermal oven 800 encloses substantially the holographic media 4 after recording (exposure) on all or most of its sides in order to heat holographic media for a sufficient period of time (e.g., one minute) and over a sufficient temperature range to fix the holographic media during the period. The holographic media can be held static or carried on a conveyor belt 804 that is driven by pulleys 805 such that the media is moved in the oven in a direction indicated by the arrow 807. The holographic media 4 can be inserted into the drive through an aperture 802 and removed at the aperture 803 when the holographic has been exposed to the requisite heating energy required to fix said holographic media. Although a single holographic media is shown in FIG. 9, multiple ones of the holographic media may be exposed at the same time in the oven.

FIG. 10 shows a holographic media 4 and HDSS with a format structure enabling multiple writing and reading sessions, where the fixing of said holographic media is carried out in localized sections. Here the fixing apparatus is external to the HDSS. The holographic media 4 is in disc format inside of a cartridge 90. The cartridge has an aperture 92, allowing a rotary motor 91 to be secured to said holographic media and rotate said media about an axis 93 in a direction indicated by the arrow 94. The cartridge 90 also has an aperture 95 allowing access of the holographic media to a fixing source 96. The fixing source 96 may be an optical source that exposes the holographic media directly, a radiant heat source, an optical source designed with wavelengths that the holographic media absorbs and converts to heat or a combination of these three sources. The source 96 is preferably an array of LEDs, or a laser, or a tungsten filament, or a heating coil. An optical system 97 between the source 96 and the holographic media 4 directs the fixing radiation towards the holographic media 4. As the rotary motor spins the holographic media 4, the entire disk can be fixed in one or a plurality of rotations thereof. Only a portion of the holographic media may be fixed, for example, where source 96 is an array of LEDs or an array of laser diodes, only selected LEDs or selected laser diodes may be illuminated at any given time such that only selected radial tracks of the holographic media disc are fixed. Where a coherent optical source is used as the fixing source 96, the media can be rotated at a speed such any interference fringes created by said optical source in the holographic media are washed out over the course of the fixing exposure. Consider an example where interference fringes are on the order of microns to tens microns apart then 500 microns of movement by the holographic media disk during the fixing time may be sufficient wash out the fringes. If the fixing time required is 20 msec and the radial track to be fixed is at a radius of 50 mm, then one requires a disk rotation speed of approximately 4.8 rpm.

Fixing of holographic media has been described as being performed either simultaneous with, or separate from a holographic writing operation, however fixing may also be performed by multiple fixing steps, such as when a single step does not sufficiently fix the media as desired. This may be achieved by first fixing in a HDSS all or part of the holographic media simultaneous with writing operation(s), as described above, and then afterwards within the same (or different) HDSS (by a reference beam or a separate optical fixing source, as described above) complete the fixing while the holographic disk is spun at a rpm higher than that the holographic drive normally operates at in order that any fringes created by a coherence source fixing the media are washed away.

From the foregoing description, it will be apparent that improved HDSS and methods of holographic data storage as provided which incorporate post exposure fixing to counteract spurious recording especially over unused dynamic range of the holographic media. Variations and modifications of the herein described methods and apparatus for implementing the invention will undoubtedly suggest themselves, to those skilled in the art. Accordingly the foregoing description should be taken as illustrative and not in a limiting sense.

1. A method of holographic data storage on a photosensitive holographic data storage media which comprises the steps of recording one or more holograms representing data at one or more locations on the media, and after such recording exposing the media with sufficient energy to fix the media against further recording in said locations.

2. The method according to claim 1 wherein said holographic media has a dynamic range capable of accepting a multiplicity of holographic images, said recording step is carried out over a portion of said dynamic range, and said exposing step is carried out over the remainder of said dynamic range.

3. The method according to claim 1 wherein said exposing step provides exposure energy over an energy range greater than that used in said recording step.

4. The method according to claim 1 wherein said exposing step is carried out using an optical source providing optical wavelengths that the holographic media is photosensitive to.

5. The method according to claim 1 wherein said exposing step is carried out using an optical source containing wavelengths that the holographic media absorbs and which causes thermal heating of the media in locations where the wavelengths are applied.

6. The method according to claim 5 wherein the exposing step is carried out using a heat source.

7. The method according to claim 1 wherein the exposing step is carried out with a heat source and an optical source.

8. The method according to claim 1 wherein said recording step uses an optical beam which is redirected to said medium to carry out said exposing step.

9. The method according to claim 8 wherein said optical beam is a reference beam.

10. The method according to claim 4 wherein said reference beam used for fixing is passed through said media and redirected to said media for fixing said media in location other than locations which is recorded with said reference beam and fixed by said reference beam on being directed through said media at a location spaced from said recording location.

12. The method according to claim 1 wherein said exposing step is carried out by flooding said media with optical, thermal or other electromagnetic energy sufficient to fix said media after recording of holographic images thereon.

11. The method according to claim 1 wherein said exposing step is carried out on said medium in a fixing station separate from a HDSS.

13. The method according to claim 1 wherein said exposing step is carried out by collecting optical energy used for recording and redirecting said energy to a location on said media where fixing is carried out.

14. The method according to claim 1 wherein the exposing step is carried out by beams oriented, diffused or having coherency insufficient to record spurious holographic images.

15. The method according to claim 13 wherein said collected light is recollected and passed through different locations of said medium on multiple passes thereby fixing a plurality of locations at the same time.

16. The method according to claim 1 wherein said exposing step is carried out at locations simultaneously with new recording at another location in said media.

17. The method according to claim 1 wherein said exposing step is carried out in multiple ones of said exposing step in order to sufficiently fix the media.

18. An apparatus for holographic data storage on a photosensitive holographic data storage media which comprises means for recording one or more holograms representing data at one or more locations on the media, and means operative after such recording for exposing the media with sufficient energy to fix the media against further recording in said locations.

19. The apparatus according to claim 18 wherein said holographic media has a dynamic range capable of accepting a multiplicity of holographic images, said recording means is operative for recording over a portion of said dynamic range, and said exposing means is operative over the remainder of said dynamic range.

20. The apparatus according to claim 18 wherein said exposing means is operative to provide exposure energy over an energy range greater than that over which said recording means is operative.

21. The apparatus according to claim 18 wherein said exposing means comprises an optical source providing optical wavelengths that the holographic media is photosensitive to.

22. The apparatus according to claim 18 wherein said exposing means comprises a source containing wavelengths that the holographic media absorbs and which causes thermal heating of the media in locations where the wavelengths are applied.

23. The apparatus according to claim 22 wherein the source is a heat source.

24. The apparatus according to claim 22 wherein said source comprises a heat source and an optical source.

25. The apparatus according to claim 18 wherein said recording means comprises means for providing an optical beam, and said exposing means comprises means for redirecting said optical beam to said media.

26. The apparatus according to claim 25 wherein recording step is operative to provide said optical beam as a reference beam.

27. The apparatus according to claim 25 wherein said recording means is operative to use said reference beam for fixing, means for passing said reference beam through said media and redirecting said reference beam which is passed through said media for fixing said media in locations other than locations which are recorded with said reference beam and fixed by said reference beam on being directed through said media at a location spaced from said recording location.

28. The apparatus according to claim 18 wherein said exposing means comprises means for flooding said media with optical, thermal or other electromagnetic energy sufficient to fix said media after recording of holographic images thereon.

29. The apparatus according to claim 18 wherein said exposing means is operative on said media in a fixing station spaced from said recording means.

30. The apparatus according to claim 18 wherein said exposing means is operative by collecting optical energy from said recording means and redirecting said energy to a location on said media where fixing is carried out.

31. The apparatus according to claim 18 wherein said exposing means is operated by a beam oriented, diffused or having coherency insufficient to record spurious holographic images.

32. The apparatus according to claim 30 wherein said exposing means operative with collected optical energy used for recording which is recollected and passed through different locations of said media on multiple passes thereby fixing a plurality of locations at the same time.

33. The apparatus according to claim 18 wherein said exposing means is effective at locations which have been recorded simultaneously with recording at another location in said media.

34. The apparatus according to claim 18 wherein said exposing means is operative by multiple exposures of said media in order to sufficiently fix the media.

35. An apparatus for fixing holographic data storage on a photosensitive holographic data storage media having one or more locations of recorded holograms, said apparatus comprising means for exposing the media with sufficient energy to fix the media against further recording in said locations.

36. The apparatus according to claim 35 wherein said exposing means is operated by a beam oriented, diffused or having coherency insufficient to record spurious holographic images.

37. The apparatus according to claim 35 wherein said exposing means comprises an optical source providing optical wavelengths that the holographic media is photosensitive to.

38. The apparatus according to claim 35 wherein said exposing means comprises a source containing wavelengths that the holographic media absorbs and which causes thermal heating of the media in locations where the wavelengths are applied.

39. The apparatus according to claim 38 wherein the source is a heat source.

40. The apparatus according to claim 38 wherein said source comprises a heat source and an optical source.

41. The apparatus according to claim 35 wherein said exposing means comprises means for flooding said media with optical, thermal or other electromagnetic energy sufficient to fix said media.

42. The apparatus according to claim 35 further comprising means for recording one or more holograms representing data at one or more locations on the media.

43. The apparatus according to claim 42 wherein said exposing means is operative on said media in a fixing station spaced from said recording means.

44. The apparatus according to claim 42 wherein said exposing means is operative by collecting optical energy from said recording means and redirecting said energy to a location on said media where fixing is carried out.

45. The apparatus according to claim 42 wherein said exposing means is operative to provide exposure energy over an energy range greater than that over which said recording means is operative.
